(19) United States
(12) Patent Application Publication
(10) Pub. No.: US 2015/0367348 A1
(43) Pub. Date: Dec. 24, 2015

(54) NUCLEIC ACID AMPLIFYING DEVICE AND METHOD FOR DETECTING ABNORMAL TEMPERATURE REGULATING FUNCTION

(71) Applicant: HITACHI HIGH-TECHNOLOGIES CORPORATION, Tokyo (JP)

(72) Inventors: Minoru SANO, Tokyo (JP); Yoshiyuki SHOJI, Tokyo (JP); Koshi MAEDA, Tokyo (JP)

(21) Appl. No.: 14/762,222

(22) PCT Filed: Jan. 27, 2014
(86) PCT No.: PCT/JP2014/051609

§ 371 Date: Jul. 21, 2015

(30) Foreign Application Priority Data
Jan. 28, 2013 (JP) 2013-012770

(51) Int. Cl. B01L 7/00

(52) U.S. Cl. CPC B01L 7/5255

(57) ABSTRACT

A nucleic acid amplification apparatus which amplifies a nucleic acid of a reaction liquid in which a specimen and a reagent are mixed includes a carousel which is provided with a plurality of temperature control blocks, each of which holds at least one reaction container in which a reaction liquid is stored, a temperature control device which is provided in the carousel, temperature control devices which are respectively provided in a plurality of temperature control blocks and adjust the temperature of the reaction liquid, a temperature control device which adjusts the temperature of the atmospheric temperature inside the nucleic acid amplification apparatus, and a control device which detects a failure from a result of measuring the temperature.

### TECHNICAL FIELD

The present invention relates to a nucleic acid amplification apparatus and a method of detecting an abnormality in a temperature control function.

### BACKGROUND ART

As an example of a nucleic acid amplification technique which is used when examining a nucleic acid contained in a specimen derived from a living body, there is a technique of using a polymerase chain reaction (hereinafter, referred to as PCR) method. In the PCR method, it is possible to selectively amplify a desired base sequence by controlling the temperature of a reaction liquid, in which a specimen and a reagent are mixed, in accordance with predetermined conditions.

In addition, as another nucleic acid amplification method, a technique, such as a nucleic acid sequence-based amplification (NASBA) method or a loop-mediated isothermal amplification (LAMP) method, has been developed which controls the temperature of a reaction liquid constant and achieves nucleic acid amplification.

Such a nucleic acid amplification technique has been actively used also in the clinical examination field, for example, for diagnosis of viral infection, and efficiency, labor saving, and high precision for an examination due to automation have been expected.

JP-A-2010-104382 discloses an apparatus which simultaneously performs amplification of a target nucleic acid with respect to a plurality of vials. The apparatus disclosed in JP-A-2010-104382 is installed in an integrated block in which vials containing a liquid reaction mixture, in which a reagent and a specimen are mixed, can be simultaneously installed by a number which can be stored in a microtiter plate, in order to amplify a plurality of vials containing the mixture, and the temperature of the block is controlled while monitoring a measurement value of a temperature sensor which is provided in the block, in accordance with a single protocol for specifically amplifying a target nucleic acid. According to the prior art, it is possible to perform batch-processing of a plurality of specimens in which analysis is performed in an identical protocol.

### CITATION LIST

### Patent Literature

PTL 1: JP-A-2010-104382

### SUMMARY OF INVENTION

### Technical Problem

In a nucleic acid amplification technique, the conditions (protocols) such as the reagent, the temperature, the time, and the like used vary depending on a base sequence of an amplification object. Accordingly, when concurrently processing a plurality of kinds of specimens which have different base sequences of amplification objects, it is necessary to individually set the temperature and the time which are defined in the protocols of various specimens.

However, in an automatic analysis apparatus which is disclosed in the above-described JP-A-2010-104382, the temperature of each incubator is controlled to be constant. Therefore, many incubators are required in order to process a plurality of protocols. Accordingly, the configuration of the apparatus and the movement procedure of reaction containers become complicated.

The present invention has been made in consideration of the above circumstances, and an object of the present invention is to provide a nucleic acid amplification apparatus which can carry out a nucleic acid analysis technique which is represented by a PCR method or a constant temperature amplification method, and particularly detects an abnormality in a temperature adjustment function efficiently.

### Solution to Problem

In order to achieve the above-described problems, the present invention employs a configuration disclosed in the claims. In a specific example, a nucleic acid amplification apparatus which amplifies a nucleic acid of a reaction liquid in which a specimen and a reagent are mixed includes a carousel which is provided with a plurality of temperature control blocks, each of which holds at least one reaction container in which a reaction liquid is stored, a temperature control device which is provided in the carousel, temperature control devices which are respectively provided in a plurality of temperature control blocks and adjust the temperature of the reaction liquid, a temperature control device which adjusts the temperature of the atmospheric temperature inside the nucleic acid amplification apparatus, and a control device which detects a failure from a result of measuring the temperature.

### Advantageous Effects of Invention

The nucleic acid amplification apparatus of the present invention enables parallel processing of analysis items, which are the same as or different from each other, and can easily realize abnormality detection in a temperature control device. That is, it is possible to avoid an analysis failure in the nucleic acid amplification apparatus in advance and to efficiently perform maintenance of the apparatus.

### BRIEF DESCRIPTION OF DRAWINGS

FIG. 1 Perspective view of nucleic acid amplification apparatus

FIG. 2 Cross-sectional side view of nucleic acid amplification apparatus

FIG. 3 Cross-sectional side view of nucleic acid amplification apparatus

FIG. 4 Plan view of nucleic acid amplification apparatus

FIG. 5 Cross-sectional side view of nucleic acid amplification apparatus

FIG. 6 Failure determination

FIG. 7 Calibration method

### DESCRIPTION OF EMBODIMENTS

Hereinafter, embodiments will be described using the drawings.

### Embodiment 1

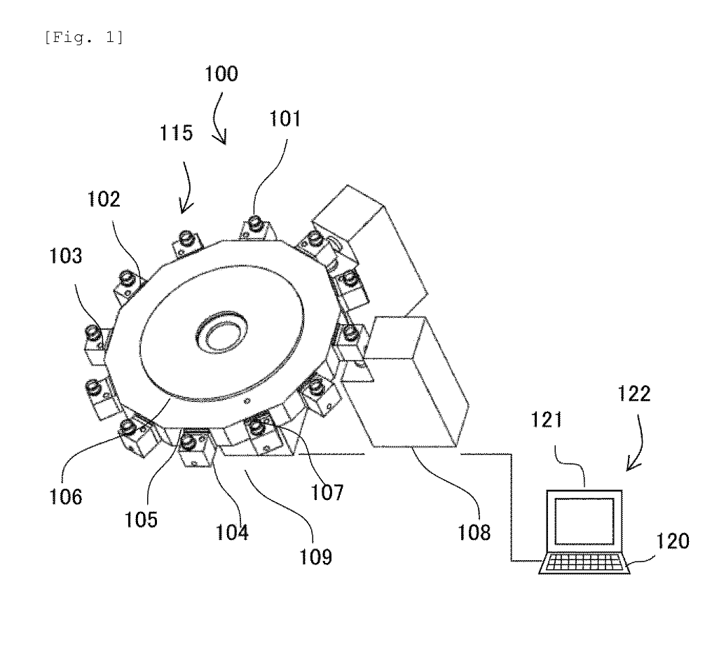

FIG. 1 is a view schematically showing an overall configuration of a nucleic acid amplification apparatus 100 according to the present embodiment. In FIG. 1, the nucleic acid amplification apparatus 100 includes a control device 122 that controls an overall operation of the nucleic acid amplification apparatus 100 which includes: a plurality of reaction containers 101 in which a specimen containing a nucleic acid as an object of amplification processing is stored; temperature control blocks 102 which hold a reaction container; a temperature sensor 103 which monitors the temperature of the temperature control block; a temperature control device 104 which adjusts the temperature of the temperature control block; a carousel 105 which fixes a plurality of temperature control blocks; a temperature control device 106 for the carousel; a temperature sensor 107 for the carousel; a detection unit 108 which performs optical measurement of a specimen which is included in a reaction container; a rotation mechanism 109 for the carousel; a rotary shaft 110 which connects the carousel to the rotation mechanism; an input device 120 such as a keyboard and a mouse; and a display device 121 such as a liquid crystal monitor. In addition, the nucleic acid amplification apparatus also includes a cover that covers the carousel and the detection unit; and a temperature sensor for measuring the atmospheric temperature of an area which is surrounded by the cover (not shown in FIG. 1).

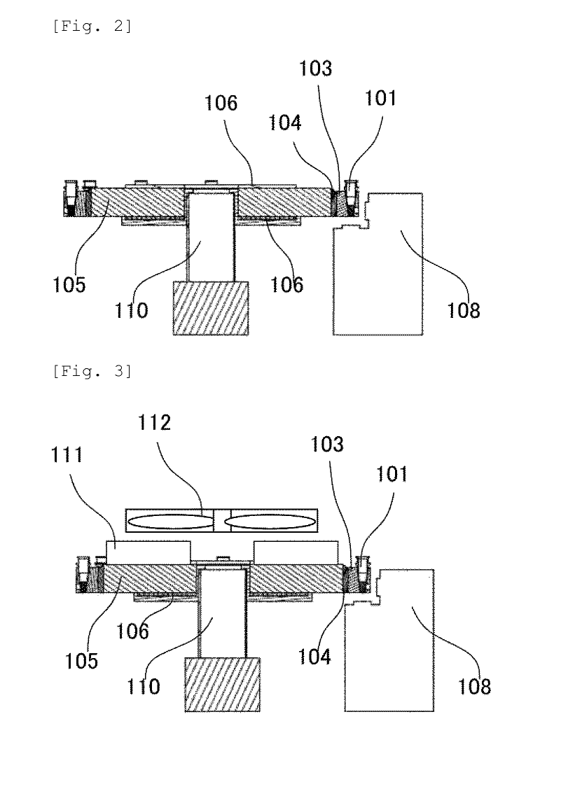

Next, the details of the nucleic acid amplification apparatus will be described using FIG. 1 (perspective view) and FIG. 2 (cross-sectional side view). One or more temperature control blocks (for example, 12 in the present embodiment) are disposed along the outer circumference around each central shaft of the carousel. If the carousel is driven to be rotated by a rotation mechanism incorporating a stepping motor, the movement of a reaction container which is installed in a temperature control block draws an identical circle. One or more detection units (for example, 2 in the present embodiment) are provided and are disposed along the outer circumference of the carousel at regular intervals. In addition, a detection unit is disposed below the reaction container. A detection window through which the reaction container is exposed is provided on a bottom surface and on a side surface in an outer circumferential direction of the temperature control block, and an optical measurement is performed while the reaction container passes through the detection unit. At this time, the optical measurement may be performed while the reaction container passes through the detection unit, or it is possible to temporarily stop the reaction container on the detection unit for the optical measurement. In addition, the detection window can be optimally set on the bottom surface, the upper surface, or the like in accordance with the structure of the detection unit. In a case where there are a plurality of detection units, the detection units independently perform detection or measurement of a reaction liquid of the reaction container.

The carousel is formed of a material such as aluminum or copper which is excellent in heat transfer properties, and the entire carousel is controlled to have uniform temperature by a temperature control device. As the temperature control device, a silicon rubber heater, a film heater, or the like is used. The temperature control device can also have a structure in which heating and cooling using a Peltier element or a combination of a cooling fin and a DC fan is more accurately controlled in accordance with a target temperature which is required for a protocol of nucleic acid amplification. When using a heater, the carousel can have a radiator fin and a DC fan in combination in order to suppress an excess increase in temperature.

In addition, in the Peltier element which is a temperature control device for a temperature control block, an endothermic surface and a radiating surface are respectively fixed to the carousel and the temperature control block by being brought into contact with the carousel and the temperature control block. For example, in a usual PCR reaction, it is possible to promptly change the temperature of the temperature control block by operating the Peltier element which is a temperature control device for a temperature control block while maintaining the temperature of the carousel at 50° C. using a heater, in order to change the temperature of the temperature control block at 50° C. to 95° C. The temperature of the carousel and the temperature of the temperature control block can be monitored by each of the temperature sensors. As the temperature sensors, a thermistor, a thermocouple, a temperature measuring resistor, and the like are used. In order to more precisely measure the temperature of the temperature control block, exposure of the temperature sensor to the atmosphere may be minimized. Specifically, the temperature sensor is inserted into a hole which is provided in the temperature control block, and in order to improve adhesion between the temperature control block and the temperature sensor, it is possible to fix the temperature sensor to a surface exposed to the atmosphere using liquid silicon rubber for fixing or the like which has heat insulation properties, by improving the contact there between using a thermal conductive grease or liquid silicon rubber for fixing which is excellent in thermal conductivity, or the like. In addition, heat transfer through a wiring is minimized by minimizing the length of the wiring, coating the wiring with a thermal insulation member, or the like, thereby contributing to improvement in accuracy of controlling the temperature.

In addition, one temperature sensor may be provided with respect to one carousel. The temperature measured by the temperature sensor can be treated as a representative temperature value of the carousel since the carousel is constituted of a member which is excellent in thermal conductivity and the distance from a heater, which is a temperature control device, is constant in an angular direction along the outer circumference of the carousel. For example, if a temperature sensor having a cylindrical shape of which the diameter is 2 mm is used when the diameter of carousel is set to 140 mm, the influence on heat transfer is small so as to be ignored. However, when the diameter of the temperature sensor is larger than that of the carousel, the temperature sensor can be disposed so as not to interrupt a heat transfer path that connects the temperature control device for the carousel and the temperature control block in order to avoid the influence on heat transfer, or the number of temperature sensors can be increased.

The temperature control device 104 or the temperature control device 106 is not limited to the above-described combination, and it is possible to freely select devices such as heater or Peltier element in accordance with embodiments.

Next, an operation in the present embodiment which is constituted as above will be described.

A reaction liquid as an analysis object is adjusted by mixing a specimen and a reagent. The adjusted reaction liquid is dispensed into reaction containers which are then installed in temperature control blocks. The method of adjusting the reaction liquid and the method of installing the reaction containers may be performed manually or automatically.

Here, nucleic acid amplification processing is carried out such that the Peltier element as a temperature control device is controlled and the temperature of the reaction containers is periodically controlled step by step based on a protocol with respect to specimens which are stored in the reaction containers held by the temperature control blocks. In this manner, in the PCR method which is a type of a nucleic acid amplification method, a target base sequence is selectively amplified by periodically changing the temperature of a reaction liquid, in which a specimen and a reagent are mixed, step by step based on a protocol corresponding to each specimen. Even in a case where a plurality of reaction containers are processed in parallel, the nucleic acid amplification processing is sequentially started from the timing when each of the reaction containers is installed in each temperature control block and the temperature of the temperature control block is periodically changed step by step based on a protocol corresponding to each specimen. During the nucleic acid processing, quantitative analysis of a target sequence in the reaction liquid is performed by rotating the carousel and detecting fluorescence from the reaction liquid over time using a detection unit. The detection results are sequentially sent to the control device.

When a predetermined nucleic acid amplification processing is completed, the reaction containers are removed from the nucleic acid amplification apparatus manually or using an automated device. In a temperature control block from which a reaction container is removed, it is possible to start nucleic acid amplification processing with respect to a next specimen.

In the nucleic acid amplification technique using the PCR method, the conditions (protocols) such as the reagent, the temperature, the time, and the like used vary depending on a base sequence of an amplification object. Accordingly, when concurrently processing a plurality of kinds of specimens which have different base sequences of amplification objects, it is necessary to individually set the temperature and the time which are defined in the protocols of various specimens. In the related art, only one kind of protocol can be dealt with at a time, and therefore, parallel processing cannot be performed in which a plurality of kinds of specimens which have different protocols are concurrently processed. In addition, it is impossible to perform processing which varies in starting time even in the case of the specimens with an identical protocol, and therefore, it is impossible to newly start processing of a different specimen until the processing under execution is completed.

In contrast, in the present embodiment, the nucleic acid amplification apparatus includes the carousel, which is provided with a plurality of temperature control blocks that hold reaction containers, in which a reaction liquid is stored, and is constituted so as to adjust the temperature of the reaction liquid using temperature control devices which are respectively provided in the temperature control blocks. Therefore, it is possible to perform parallel processing of a plurality of kinds of specimens which have different protocols and to start processing a different specimen even during processing under execution, and thus, it is possible to greatly improve processing efficiency.

Furthermore, in the present embodiment, it is possible to appropriately select and install a plurality of detection units in accordance with a fluorescent pigment required, and therefore, the device is excellent in function extensibility.

In addition, a thermal capacity sufficiently larger than that of a temperature control block is provided in the carousel in order to facilitate reproducibility when repeating the control of the temperature of an individual temperature control block. Accordingly, the carousel can prevent the temperature of a local portion, which is bound to a temperature control device for a temperature control block, from changing due to inflow or outflow of heat from the temperature control device for a temperature control block, and can keep the amount of heat transferred using the temperature control device, which is a Peltier element, constant. This is based on the fact that the amount of heat which is transferred by the Peltier element is correlated with a difference in the temperature between the radiating surface and the endothermic surface.

In addition, it is possible to more accurately achieve the temperature adjustment using a control device through provision of a function of forced cooling against the heating by the temperature control device as a heater by providing a radiation fin shape on the surface of the carousel or installing an appropriate number of heat sinks 111 which have a general fin shape used for cooling an electronic apparatus, and using a DC fan 112, as shown in FIG. 3, in order to control the temperature of the carousel constant. It is possible to use a Peltier element instead of the heater as the temperature control device for the carousel.

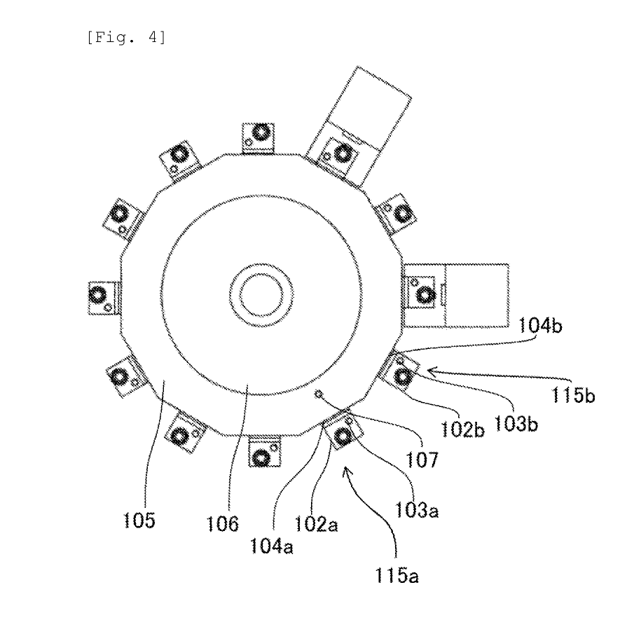

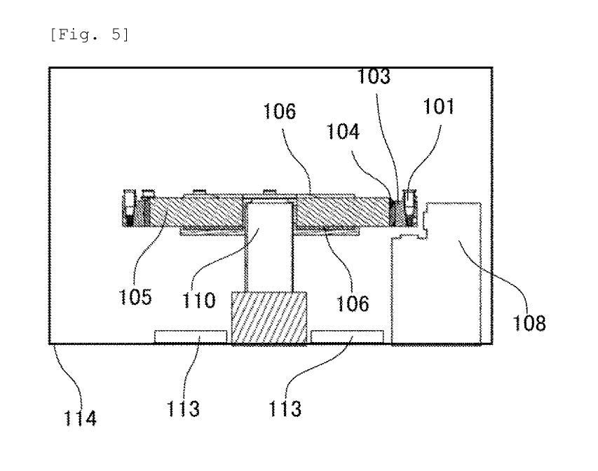

Next, a configuration for detecting a failure in a temperature controlling function will be described using FIG. 4. It is necessary to carry out precise control of the temperature in accordance with a protocol in order to accurately carry out the nucleic acid amplification processing. In the present embodiment, a temperature control device 104a and a temperature sensor 103a are provided in order to adjust the temperature of a reaction liquid. A pair of temperature controlling device and a temperature sensor is provided with respect to each temperature control block and is installed such that the distances from a disc-shaped heater, which is a temperature control device which is installed on the carousel, to the pairs of the temperature controlling devices and the temperature sensors are made to be equal to each other. In addition, the shapes or the component configurations are made to be equal to each other such that the heat transfer paths are equal to each other as well as in the case of the distance.

A processing method for detecting a failure in a temperature sensor (for example, 103a) which is installed in a temperature control block (for example, 102a) will be described. The nucleic acid amplification apparatus is allowed to stand under the installation environment, and temperature measurement value, which is output to the control device 122 from the temperature sensor 103a of each of the temperature control blocks 102a, are analyzed. At this time, the temperature control devices are not operated. It is expected that the temperature of the temperature control blocks is the same as the environmental temperature, or specifically, the same as the atmospheric temperature inside the cover. Therefore, the temperature control blocks 102, which outputs abnormal temperature data to the extent which exceeds an allowable error range compared to the temperature which is output from a temperature sensor (not shown in the drawing) which measures the atmospheric temperature inside the cover, can identify an occurrence of an abnormality or a failure in the temperature sensor 103a or a structure (not shown in the drawing) for fixing the temperature sensor 103a. Here, the comparison between the temperature data pieces may be performed between the temperature control blocks (for example, 102a), or may be performed by combining temperature data pieces of the temperature sensors for measuring the atmospheric temperature which is covered by a cover. It is possible to identify an abnormal place with high accuracy by appropriately selecting the method and the combination thereof.

For example, when temperature data pieces output from temperature sensors (for example, 103a) which are installed in temperature control blocks (for example, 102a) are within an error range which is allowable in each of the temperature sensors, it is possible to identify a failure in the temperature sensors if the temperature data pieces which are output from the temperature sensors for measuring the atmospheric temperature which is covered by a cover are regarded as abnormal.

It is possible to provide a calibrated external thermometer or a calibrated external temperature measuring probe for this method. For example, when a result is obtained in which a failure in the temperature sensors for measuring the atmospheric temperature which is covered by a cover is suspected, it is possible to more accurately identify the failure in the temperature sensors by installing a calibrated external thermometer in the cover and by comparing obtained temperature data pieces.

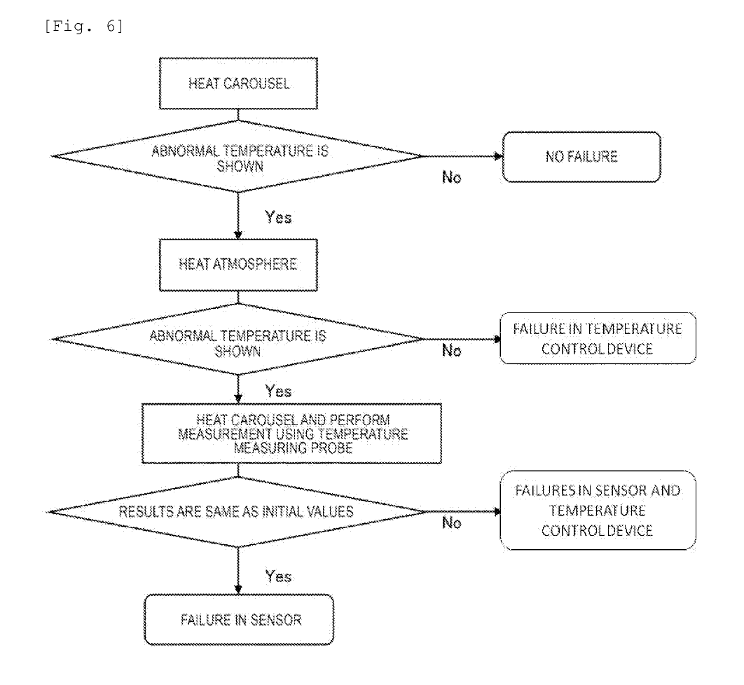

In addition, the atmospheric temperature inside the cover of the nucleic acid amplification apparatus is set to one or a plurality of temperatures, which are suitable in the temperature range used for nucleic acid amplification, using a configuration shown in FIG. 5, and temperature data pieces which are output from the temperature sensors (for example, 102a) when the atmospheric temperature reaches each temperature are investigated, thereby detecting an abnormality in the entire temperature range required for nucleic acid amplification. In FIG. 5, the atmosphere inside the device which is surrounded by a cover 114 of the nucleic acid amplification apparatus can increase the temperature using a heat source 113 which is provided in a base portion. A temperature sensor may be provided (not shown in the drawing) or airflow control function using a fan or a duct may be added thereto (not shown in the drawing), and it is possible to keep the atmospheric temperature at a target temperature by appropriately controlling the operation thereof. In addition, in order to easily make the temperature of a temperature control block uniform and to easily reach the atmospheric temperature, it is possible to provide a structure, such as a fin, in a temperature control block to promote heat exchange, or to add a structure for optimizing or appropriately controlling the direction or the speed of the airflow.

It is possible to more stably detect a failure by performing the process of detecting an abnormality in the temperature sensor 103a in a state where nucleic acid amplification processing has not been carried out, that is, during maintenance of the device. Accordingly, when temperature control blocks (for example, 102a) cannot normally adjust the temperature, this situation is detected in advance and the temperature control blocks are repaired, for example, components are replaced or the control device 122 is instructed to stop the use of the temperature control blocks (for example, 102a) and to use only other temperature control blocks which normally operate. Accordingly, it is possible to prevent any failure in the nucleic acid amplification processing and to efficiently perform maintenance.

In addition, the process of detecting an abnormality in the temperature sensor 103a may be performed during operation of the nucleic acid amplification apparatus or in the middle of analysis as well as during maintenance. As an example of this mode, a temperature control well (for example, 115a) can be automatically specified by the control device 122 or can be specified by a user to concurrently perform maintenance in the middle of analysis of the nucleic acid amplification apparatus, and the processing of detecting an abnormality can be performed by comparing temperature data pieces from the temperature sensors instead of performing the nucleic acid amplification processing in the temperature control well (for example, 115a). When there is a temperature control well 115 which does not perform the nucleic acid amplification processing, the processing of detecting an abnormality can be performed in the temperature control well so as not to influence a specimen processing schedule of a nucleic acid analysis device. In addition, it is possible to incorporate the processing into the specimen processing schedule. In addition, when it is necessary to especially verify another accuracy at the time when the obtained analysis result of the nucleic acid amplification is abnormal, it is possible to perform scheduling through automatic determination or the user's determination so as to perform the processing of detecting an abnormality in the temperature control well 115a in which the analysis has been performed. With this function, it is possible to more efficiently operate the nucleic acid amplification apparatus and to support the obtained analysis result. This function can be performed by being combined with other embodiments of the present invention.

### Embodiment 2

The process of detecting an abnormality in the temperature sensor 103a may be performed in a state where the temperature control device 106 for the carousel 105 or the temperature control devices for the temperature control block 102a is operated as described above. As an example, a case of adjusting the temperature of the carousel 105 will be described below. The temperature control device 106 for the carousel 105 is operated and the temperature thereof is made to reach a predetermined target temperature while monitoring and feeding back temperature data pieces which are output from the temperature sensor 107, and then, is controlled so as to keep the temperature at a target temperature. At this time, the structures, the distances, and the like from the temperature control device 106 to the temperature control blocks (for example, 102a) are equal to each other, and therefore, thermal characteristics between the temperature control device 106 and the temperature control blocks (for example, 102a) are equal to each other. For this reason, if the temperature sensors (for example, 103a) of the temperature control blocks (for example, 102a) are normally operated, the temperature data pieces which are output from the temperature sensors become the same value as each other. In contrast, in comparison with temperature data pieces which are output from other temperature sensors (for example, 103a), or in comparison with constant temperature data pieces which are offset by temperature data pieces output from the temperature sensor 107 of the carousel 105, it is considered that there is a possibility that temperature sensors (for example, 103a) which output abnormal temperature data pieces that exceed a predetermined error range, are out of order, and therefore, it is possible to efficiently detect a failure.

Here, the heater which is a temperature control device is not limited to have a disc shape. In this system, the heater may have any shape as long as the thermal characteristics, such as heat resistance or heat capacity between the carousel and temperature control blocks or temperature sensors, are equal in the relationship between the temperature control blocks. For example, it is possible to realize this system even with provision of a heater having a square shape at the center of the carousel. At this time, by making the material of the carousel be excellent in thermal conductivity or by setting the time until the temperature data pieces for comparison are output to be sufficiently long, the area of the carousel which comes into contact with or approaches the temperature control devices or the temperature control blocks is within a constant error range regardless of temperature control devices or the temperature control blocks, which can be regarded as being uniform, and therefore, equivalent thermal characteristics are realized.

In addition, a thermal transfer sheet is interposed between a radiating surface/endothermic surface of a Peltier element which is a temperature control device for a temperature control block and a contact surface with the carousel or the temperature control block in order to improve heat transfer properties (not shown in the drawing). An abnormal value of a temperature sensor can also be caused by a state where the heat transfer properties between the temperature control device 104a and the carousel 105 or the temperature control device 104a and the temperature control block 102a are changed due to aging or changed due to an attachment defect or the like, as well as by a failure relating to the above-described temperature sensor or fixation of the temperature sensor. Furthermore, change in heat transfer properties of the temperature control device 104a which is a heat transfer path from the carousel 105 also becomes a cause of an abnormality. For example, in a case where a Peltier element is used for the temperature control device 104a, the thermal conductivity changes due to deterioration in a soldering portion of a semiconductor element which produces a Seebeck effect in which the endothermic surface and the radiating surface are bound to each other, caused by excessive use frequency or time of the temperature control function. Accordingly, when the carousel 105 is heated by the temperature control device 106, the temperature difference between the carousel 105 and the temperature control block 102a becomes large. For this reason, according to the mode of the present example, it is possible to detect the temperature control well 115 which has a failure in the temperature sensor 103a, a failure in the temperature control device 106 which binds the carousel 105 and the temperature control block 102a together, or an abnormality in a joint state of a component between these components.

In addition, an open surface other than the surface joined with a temperature control device for a temperature control block is installed so as to cover a member such as a heat insulating material to reduce heat radiation. Accordingly, it is possible to efficiently guide heat generated from the temperature control device 106 or the temperature control device 104a to the temperature control block 102a and to improve the sensitivity of abnormality detection by reducing heat entering through other paths.

In addition, it is possible to secure normal operation of the temperature control blocks (for example, 102a) in the entire temperature range required for nucleic acid amplification by setting the temperature, at which failure detection is performed, to one or a plurality of temperatures, which are suitable in the temperature range used for nucleic acid amplification apparatus, investigating temperature data pieces which are output from the temperature sensors (for example, 103a), and detecting an abnormality.

In addition, it is possible to easily detect and predict deterioration in heat transfer properties between a temperature sensor or the carousel and a temperature control block or to easily identify a deterioration place, by recording initial values of measurement temperatures of temperature control wells and comparing measurement values with the initial values in a state where the temperature of the carousel is maintained constant using the temperature control device. Specifically, for example, in temperature measurement values which are acquired during initial maintenance such as delivery inspection of the nucleic acid amplification apparatus, in a thermally normal state, the carousel indicates Ta° C. and temperature control wells indicate a temperature within a range of Tb±Tc (±Tc indicates an error), and these temperature data pieces are recorded in the control device. In a case where the temperature of a certain temperature control well is out of the range of Tb±Tc in the same state as that of the apparatus which has acquired initial temperature data pieces, when performing maintenance after the nucleic acid amplification apparatus has been used for a certain period of time, an occurrence of an abnormality is suspected in the temperature control well.

Here, as a determination index for detecting an abnormality in a temperature control well, other data pieces which express thermal characteristics may be used as well as the temperature in the thermally normal state. Examples thereof include a heat resistance value between element components constituting the present invention, or the temperature rise/decrease rate of a temperature control well.

In addition, it is possible to more accurately perform failure detection using a temperature measuring probe (not shown in the drawing) which is a third temperature sensor in addition to the temperature sensor 107 or the temperature sensor 103 which is fixed to the carousel 105 or the temperature control well 115 in order to measure only the temperature of each component. Examples of a mode of the temperature measuring probe include a probe which includes a temperature sensor therein, has a shape imitating the shape of a reaction container, and can be installed in the temperature control block 102a, and of which the temperature is calibrated. In a state of being installed in the temperature control block 102a of which the internal temperature is uniform, the temperature measuring probe is equivalent to the temperature sensor 103a with respect to the degree at which the heat balance is governed by the temperature control block 102a. Therefore, temperature data pieces output from the temperature measuring probe and the temperature sensor 103a are close to each other, or have a constant temperature difference which does not change in each of the temperature control blocks 102a. When there is an abnormality in a constituent component such as the temperature control well 115, it is possible to detect a more minute abnormality by comparing the temperature measurement probe, of which the temperature is calibrated, and the temperature data pieces of the temperature sensor 103a. It is possible to perform more prompt failure detection using the temperature measuring probe formed of a member, such as copper, aluminum, or silver, which is excellent in heat transfer properties. In addition, in the abnormality detection using the temperature measuring probe, it is possible to efficiently perform maintenance of the nucleic acid amplification apparatus by adding a robot arm to the nucleic acid amplification apparatus and by automating the installation and removal of the temperature control well to/from the temperature measuring probe.

In addition, the temperature measuring probe can be used in calibration for correcting the difference between a target temperature in the temperature control well 115 for the nucleic acid amplification processing and the actual temperature which is caused by an error or the like of a component constituting the temperature control well 115. This calibration method will be described using FIG. 7. The subject of the target temperature in the temperature control well 115 is a mixed liquid (hereinafter, reaction liquid) of a specimen and a reagent which is stored in a reaction container to be installed. When the temperature control well 115 is controlled to have a uniform temperature, the temperature of an installed reaction liquid and the temperature of a temperature measuring probe are configured so as to be the same as each other or have a certain temperature difference. The certain temperature difference is stored in the control device and is corrected, and therefore, both of the reaction liquid and the temperature measuring probe can be treated as a reaction liquid and a temperature measuring probe which substantially show the same temperature.

In acquisition of a characteristic curve of temperature sensors in Procedure 1, when the temperature control device 104 is controlled so that temperature data pieces which are output by a temperature measuring probe which is installed in the temperature control well 115 became equal to one or a plurality of different target temperatures (here, three points of A° C., B° C., and C° C.), an approximate straight line is acquired through a least square method or an approximate curve is acquired through other approximation methods, by obtaining temperature data pieces A′° C., B′° C., and C′° C. which are output from temperature sensors (for example 103a). Next, in comparison between the characteristic curve of the temperature sensors and a target temperature (temperature of a temperature measuring probe) and acquisition of correction values, in Procedure 2, the difference in a specific temperature between the approximate straight line or curve which is obtained in Procedure 1, and an ideal calibration straight line or curve without any correction, is set to a correction value which is stored in the control device 122. The correction value is added to the target temperature, which is used for control, as a correction value of the temperature used in the nucleic acid amplification processing.

Calibration is performed in the temperature control well 115 and the obtained correction values and the results of the calibration are stored in the control device. Nucleic acid amplification processing is performed after correcting the target temperature, which is specialized for each technique of analyzing a nucleic acid or a detection item, for the each temperature control well 115 using the control device 122 based on the data of the calibration.

With this function, it is possible to precisely control the temperature and to precisely detect an abnormality in the temperature measurement function or the like.

### Embodiment 3

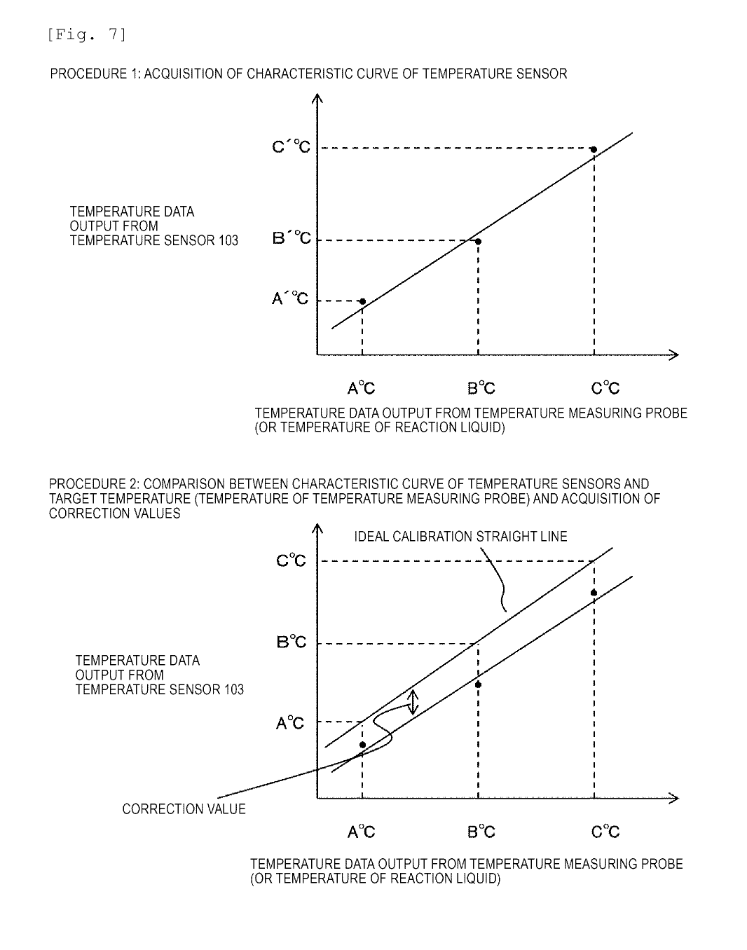

A procedure in which a failure spot can be accurately identified will be described using a specific example of FIG. 6. First, if no abnormality is found in temperature measurement values in temperature control blocks when heating a carousel and the temperature control blocks using a temperature control device for a carousel, there is no failure spot. Next, if the temperature measurement results of the temperature control blocks are normal when the atmospheric temperature is changed, it is determined that there is a failure in a temperature control device for a temperature control block. Furthermore, in a case where there is a change in the temperature compared to an initial value after measuring the temperature by heating the carousel again and installing a temperature measuring probe in the temperature control block, it is possible to determine that there are failures in both of the temperature control device and a temperature sensor. In contrast, it is possible to determine that there is a failure in the temperature sensor if there is no change in the temperature.

After it is determined that there is a failure, it is possible to continuously operate the nucleic acid amplification apparatus by continuously operating other temperature control wells after removing a temperature control well with a failure from a subject to be used, until a measure is taken for the failure by a service engineer.

### REFERENCE SIGNS LIST

100 nucleic acid amplification apparatus
101 reaction container
102 temperature control block
103 temperature sensor
104 temperature control device
105 carousel
106 temperature control device
107 temperature sensor
108 detection unit
109 rotation mechanism
110 rotary shaft
111 heat sink
112 fan
113 heat source
114 cover
115 temperature control well
120 input device
121 display device
122 control device

1. A nucleic acid amplification apparatus which amplifies a nucleic acid of a reaction liquid in which a specimen and a reagent are mixed, comprising:
a carousel which is provided with a plurality of temperature control blocks, each of which holds at least one reaction container in which a reaction liquid is stored;
first temperature control devices which are respectively provided in a plurality of temperature control blocks and adjust the temperature of the reaction liquid;
first temperature sensors which measure the temperatures of temperature control blocks;
a second temperature control device which is provided in the carousel; and
a second temperature sensor which is provided in the carousel.

2. The nucleic acid amplification apparatus according to claim 1,
wherein the distances between a heat source of the second temperature control device which is provided in the carousel, and the temperature control blocks which are respectively provided in the carousel, are equal to each other.

3. The nucleic acid amplification apparatus according to claim 2,
wherein the first temperature control devices for the temperature control blocks are disposed at positions at which the heat source provided in the carousel and reaction containers of the temperature control blocks are installed, or on a heat transfer path which connects a temperature sensor and has less heat resistance.

4. The nucleic acid amplification apparatus according to claim 1,
wherein an abnormality in a temperature measuring function is detected by comparing the differences in the measurement temperature output from the first temperature sensors which are respectively provided in the temperature control blocks.

5. The nucleic acid amplification apparatus according to claim 4,
wherein an abnormality in a temperature measuring function is detected by operating the second temperature control device which is provided in the carousel and changing the temperatures of the temperature control blocks to uniform temperatures, to compare the differences in the measurement temperature output from the first temperature sensors which are respectively provided in the temperature control blocks.

6. The nucleic acid amplification apparatus according to claim 1,
wherein a third temperature control device is provided in order to control the internal temperature of the nucleic acid amplification apparatus.

7. The nucleic acid amplification apparatus according to claim 6,
wherein a temperature control block includes a portion in which airflow inside the nucleic acid amplification apparatus, of which the temperature is controlled, and heat exchange occur.

8. The nucleic acid amplification apparatus according to claim 7,
wherein when the internal temperature of the nucleic acid amplification apparatus is changed, airflow is formed such that the temperatures of the temperature control blocks are uniformly changed.

9. The nucleic acid amplification apparatus according to claim 8,
wherein an abnormality in a temperature measuring function is detected by comparing the differences in the measurement temperature output from the first temperature sensors which are respectively provided in the temperature control blocks.

10. The nucleic acid amplification apparatus according to claim 9,
wherein an abnormality in a temperature measuring function is detected by changing the internal temperature of the nucleic acid amplification apparatus and changing the temperatures of the temperature control blocks to uniform temperatures, to compare the differences in the measurement temperature output from the first temperature sensors which are respectively provided in the temperature control blocks.

11. The nucleic acid amplification apparatus according to claim 10,
wherein an abnormality in a temperature measuring function is detected by comparing the result in which the second temperature control device which is provided in the carousel is operated, the temperatures of the temperature control blocks are changed to uniform temperatures, and the differences in the measurement temperature output from the first temperature sensors which are respectively provided in the temperature control blocks are compared, and the result in which the internal temperature of the nucleic acid amplification apparatus is changed, the temperatures of the temperature control blocks are changed to uniform temperatures, and the differences in the measurement temperature output from the first temperature sensors which are respectively provided in the temperature control blocks are compared.

12. The nucleic acid amplification apparatus according to claim 11,
wherein the temperature control devices for the temperature control blocks are arranged between the temperature control blocks and the carousel so as to make a heat transfer path.

13. The nucleic acid amplification apparatus according to claim 3,
wherein an abnormality in a state where the temperature control blocks, the temperature control devices for the temperature control blocks, and the carousel are joined together, or in a heat transfer state is detected by comparing the result in which the first temperature control devices which are respectively provided in the temperature control blocks are operated, the temperatures of the temperature control blocks are changed to uniform temperatures, and the differences in the measurement temperature output from the first temperature sensors which are respectively provided in the temperature control blocks are compared, and the result in which the internal temperature of the nucleic acid amplification apparatus is changed, the temperatures of the temperature control blocks are changed to uniform temperatures, and the differences in the measurement temperature output from the first temperature sensors which are respectively provided in the temperature control blocks are compared.

14. The nucleic acid amplification apparatus according to claim 1,
wherein a failure spot is identified by recording temperature measurement values, which are shown by the second temperature sensor for the carousel, and normal values of temperature measurement values, which are shown by the first temperature sensors of the temperature control blocks, and by comparing the recorded normal values and new measurement values.

15. The nucleic acid amplification apparatus according to claim 1,
wherein an abnormality in a temperature measuring function is detected by comparing temperature measurement values, which are shown by a calibrated third temperature sensor, and temperature measurement values, which are shown by the first temperature sensors of the temperature control blocks.

16. The nucleic acid amplification apparatus according to claim 15,
wherein the calibrated third temperature sensor is a temperature sensor which is used for correcting the difference between the temperature of a reaction liquid which is stored in the reaction containers that are installed in the temperature control blocks and is formed of an analysis sample and a liquid medicine, and the temperature measurement values which are shown by the first temperature sensors of the temperature control blocks.

17. The nucleic acid amplification apparatus according to claim 1,
wherein detection of an abnormality in a temperature controlling function is performed before a nucleic acid amplification process starts or concurrently with the nucleic acid amplification process.

18. An analysis method of performing detection of an abnormality in a temperature control function or a temperature measuring function by comparing outputs from temperature sensors for a plurality of temperature control blocks which are provided in a carousel.
